(19) United States
(12) Patent Application Publication
(10) Pub. No.: US 2010/0263493 A1
(43) Pub. Date: Oct. 21, 2010

(54) LONG HANDLE STRIKING TOOL AND SLIDING HANDLE

(76) Inventor: Joseph Savalla, Rockford, IL (US)

Correspondence Address: MICHAEL RIES, 318 PARKER PLACE, OSWEGO, IL, 60543, US

(21) Appl. No.: 12/727,937

(22) Filed: Mar. 19, 2010

Related U.S. Application Data
(60) Provisional application No. 61/170,643, filed on Apr. 19, 2009.

(51) Int. Cl. B25G 1/00; B25D 1/00; B26B 23/00

(52) U.S. Cl. 81/20; 81/489; 30/308.1; 30/312

(57) ABSTRACT

The present invention is an improved long handle striking tool that provides increased speed, accuracy, efficiency, power and impact that also reduces user fatigue and improves user safety. The tool has a handle with a distal end and a proximal end with a striking tool head disposed on the distal end of the handle. There is also a sliding handle assembly that slides along the handle that includes a movable bushing to reduce friction and wear that is in direct contact with the handle and an assembly handle grip that is set on top of the bushing. There is also a plurality of fastening devices to hold the assembly handle grip and bushing together, a head mount that mounts the striking head to the distal end of the handle and a proximal handle grip attached on the proximal end of the handle. The handle can also be utilized separately.

This application claims priority to U.S. Provisional Application 61/170,643 filed on Apr. 19, 2009, the entire disclosure of which is incorporated by reference.

### TECHNICAL FIELD & BACKGROUND

The present invention generally relates to an improved long handle striking tool and sliding handle. More specifically, the invention is an improved long handle striking tool and sliding handle designed for sledge hammers, pick axes, mauls, axes and any other long handled striking tools.

It is an object of the invention to provide an improved long handle striking tool and sliding handle that can improve user safety.

It is an object of the invention to provide an improved long handle striking tool and sliding handle that can increase speed, accuracy, power, impact and reduce user fatigue.

What is really needed is an improved long handle striking tool and sliding handle designed for sledge hammers, pick axes, mauls, axes and any other long handled striking tools that can increase speed, accuracy, efficiency, power and impact, while reducing user fatigue and improving user safety.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a front perspective view of an improved long handle striking tool and sliding handle, in accordance with one embodiment of the present invention.

FIG. 2 illustrates a side perspective view of an improved long handle striking tool, in accordance with one embodiment of the present invention.

FIG. 3 illustrates a front perspective view of a sliding handle assembly of an improved long handle striking tool, in accordance with one embodiment of the present invention.

FIG. 4 illustrates a cross-sectional side perspective view along line 4-4 of FIG. 3 of a sliding handle assembly of an improved long handle striking tool, in accordance with one embodiment of the present invention.

FIG. 5 illustrates a front perspective view of a proximal handle grip of an improved long handle striking tool, in accordance with one embodiment of the present invention.

FIG. 6 illustrates a cross-sectional side perspective view along line 6-6 of FIG. 5 of a proximal handle grip of an improved long handle striking tool, in accordance with one embodiment of the present invention.

FIG. 7 illustrates a front side perspective view of a sledge hammer head guard of an improved long handle striking tool, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

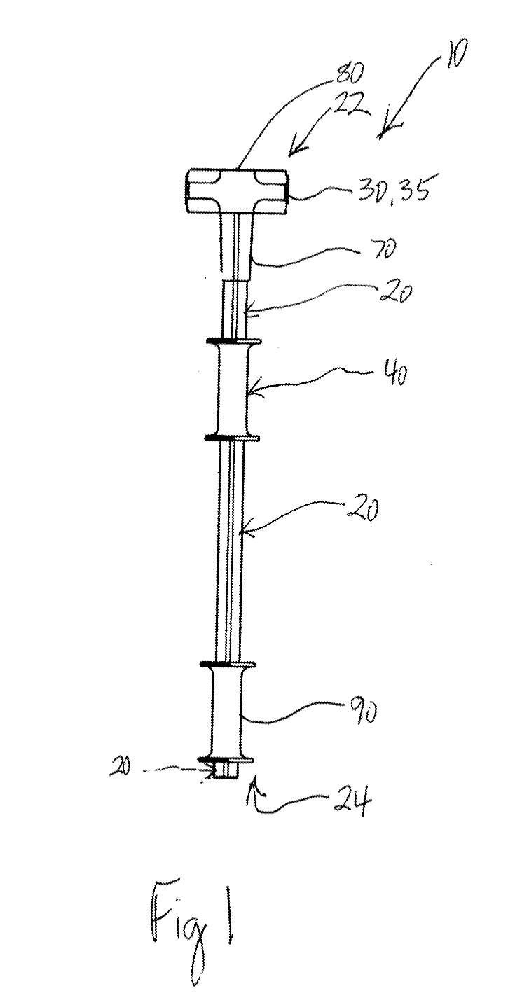

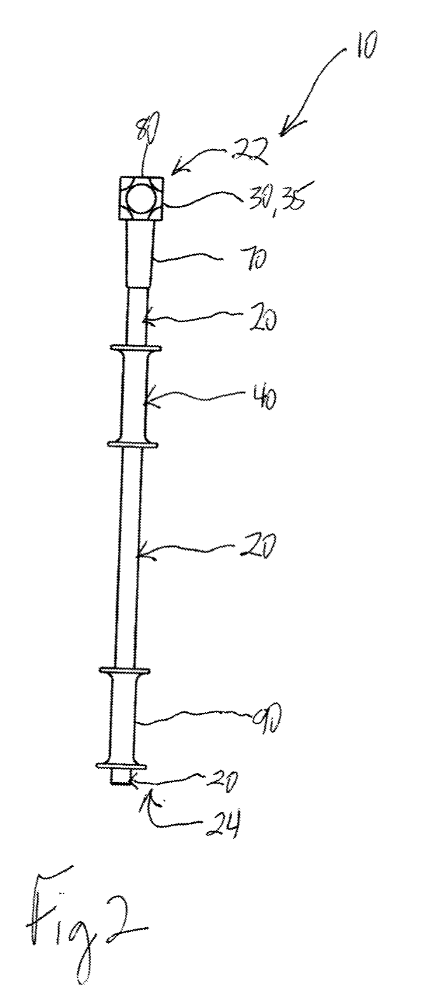

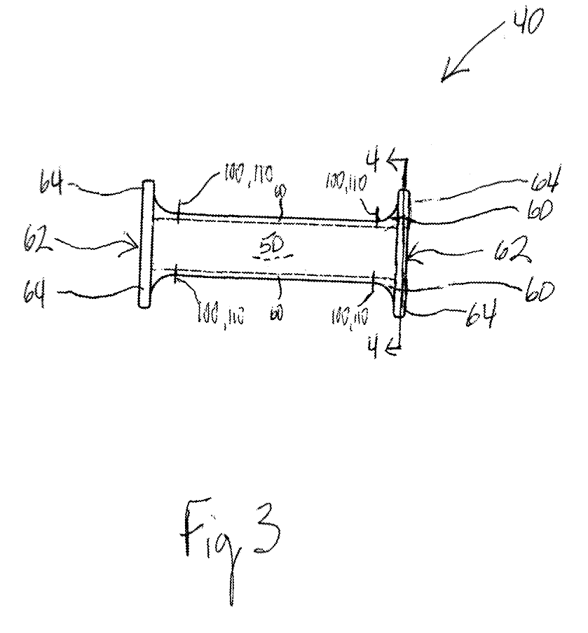

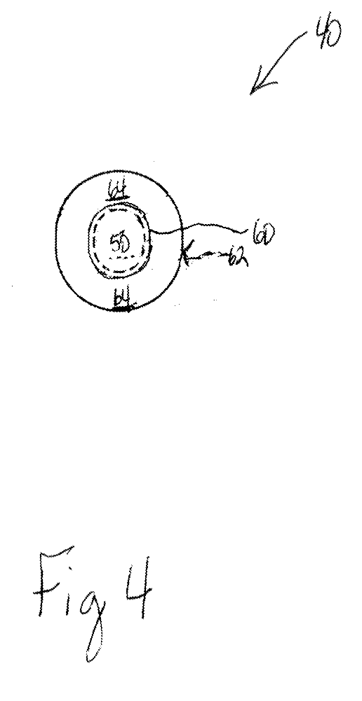

FIG. 1 illustrates a front perspective view and FIG. 2 illustrates a side perspective view of an improved long handle striking tool 10 used by a user (not shown), in accordance with one embodiment of the present invention. The improved long handle striking tool 10 provides increased speed, accuracy, efficiency, power and impact that also reduces the user's fatigue and improves the user's safety, in comparison to a user using a conventional long handle striking tool (not shown). The improved striking tool 10 has a handle 20 with a distal end 22 and a proximal end 24, with a striking tool head 30 disposed on the distal end of the handle 22 that performs a striking work function. A striking tool is a tool that is used for a striking work function, which is a work function or task that requires a significant physical impact and striking force by the striking tool. Long handle striking tools include a sledge hammer, a pick axe, a maul and an axe, but are not limited to only these described long handled striking tools. These are in contrast to short handled tools such as hammers, hatchets and wrenches, for example. Long handle striking tool heads 30 include a sledge hammer head, a pick axe head, a maul head and an axe head, but are not limited to only these described long handled striking tool heads 30. The striking head 30 illustrated in FIG. 1 and FIG. 2 is a sledge hammer head 35. The improved long handle striking tool 10 also utilizes a sliding handle assembly 40 that slides along the handle 20 when gripped by the user. Details regarding the sliding handle assembly 40 are illustrated in FIG. 3 and FIG. 4 and described in greater detail in the FIG. 3 and FIG. 4 description.

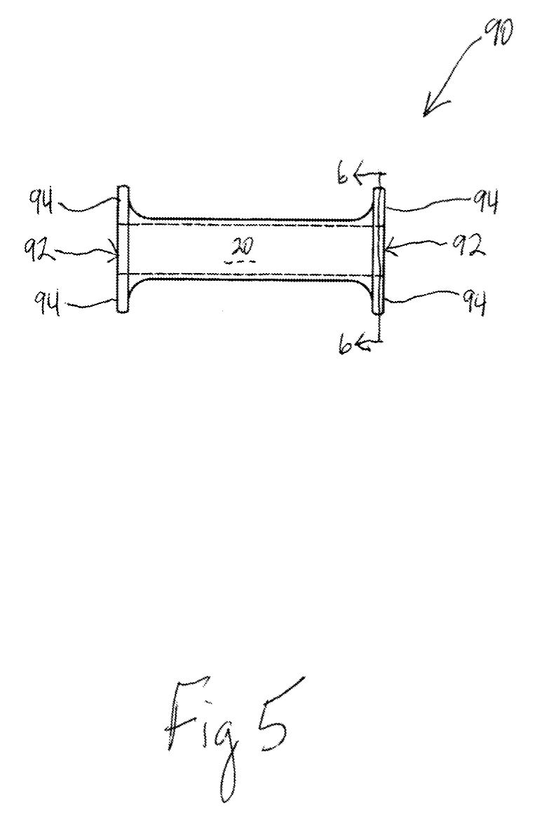

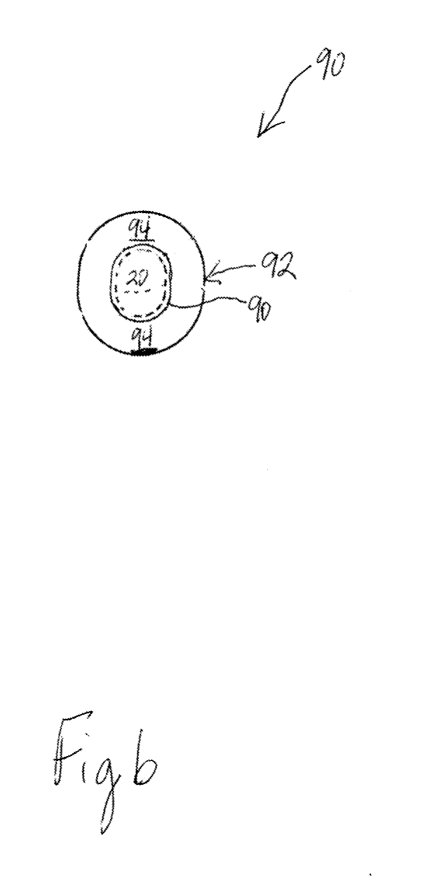

The improved long handle striking tool 10 also has a head mount 70 and a head wedge 80 that mounts and attaches the striking head 30 to the distal end of the handle 22. The head mount 70 can also be reinforced to provide overstrike protection for the handle 20 to extend the working life of the long handle striking tool 10, although a reinforced head mount 70 is optional. Other conventional ways of mounting and attaching striking heads 30 that are well known to those schooled in the art can also be used as long as they don't impede the use and performance of the improved long handle striking tool 10. The optional reinforced head mount 70 can be reinforced by any materials that are well known to those schooled in the art that provide overstrike protection for long handle striking tools. There is also a proximal handle grip 90 attached on the proximal end of the handle 24 that also allows the user to grip the proximal end of the handle 24. Details regarding the proximal handle grip 90 are illustrated in FIG. 5 and FIG. 6 and described in greater detail in the FIG. 5 and FIG. 6 descriptions.

FIGS. 3 illustrates a front perspective view and FIG. 4 illustrates a cross-sectional side perspective view along line 4-4 of FIG. 3 of a sliding handle assembly 40 of an improved long handle striking tool 10, in accordance with one embodiment of the present invention. The handle assembly 40 includes a movable bushing 50 to reduce friction and wear that is in direct slidable contact with the handle 20. A bushing is defined as a cylindrical metal sleeve used to prevent abrasion as a bearing, or as a guide for tool parts. The movable bushing 50 is a linear bearing bushing or linear slide that is designed to provide free motion in one direction. In the sliding handle assembly 40, that one dimension is along the handle 20 of the improved long handle striking tool 10. The movable bushing 50 can be a linear ball bearing bushing (not shown) that utilizes a plurality of ball bearings (not shown) or any other type of linear bearing (not shown) that is well-known to those schooled in the art. Although the movable bushing 50 can be a linear bushing that moves along the handle 20, the movable bushing 50 is not limited to a linear bearing bushing and can be any type of general sliding device used to reduce friction and wear and increase ease of use, as long as it does not impede the sliding movement of the sliding handle assembly 40 along the handle 20.

There is also an assembly handle grip 60 for the user to grip the handle assembly 40 that is set on top of the movable bushing 50. The assembly handle grip 60, the movable bushing 50 and the entire sliding handle assembly 40 move down the handle 20 as a user is gripping and swinging the improved long handle striking tool 10. This movement, results in improved speed, accuracy, efficiency, power and impact that also reduces user fatigue and improves user safety, in comparison to traditional long handle striking tools that do not have the sliding handle assembly 40, movable bushing 50 and assembly handle grip 60. The assembly handle grip 60 has two ends 62, one on each end of the assembly handle grip 60 and a raised circumferential edge 64 disposed on each of its ends 62 for improved gripping. The entire sliding handle assembly 40, movable bushing 50 and assembly handle grip 60 all slide freely in one direction along the handle 20 while in use.

The improved long handle striking tool 10 also has a plurality of fastening devices to hold the assembly handle grip 60 and the movable bushing 50 together forming the sliding handle assembly 40, while still allowing the handle assembly 40 to slidably move freely along the handle 20. The fastening devices can be a plurality of removable threaded screws 100 and tightening nuts 110 used to hold the sliding handle assembly 40 together. The fastening devices can also be a plurality of removable threaded bolts and tightening nuts (not shown) used to secure the sliding handle assembly 40 together. Although these mentioned fastening devices can be successfully used, other fastening devices not mentioned that are well known to those skilled in the art can also be used as long as they do not impede the sliding handle assembly 40 from sliding freely along the handle 20 of the improved long handle striking tool 10.

FIG. 5 illustrates a front perspective view and FIG. 6 illustrates a cross-sectional side perspective view along line 6-6 of FIG. 5 of a proximal handle grip 90 of an improved long handle striking tool 10, in accordance with one embodiment of the present invention. The proximal handle grip 90 is integral to the handle 20 and does not move while the improved striking tool 10 is being used and does not move at any time; since the proximal handle grip 90 and the handle 20 are one piece. The proximal handle grip 90 can utilize any materials and surfaces that are well known to those schooled in the art to increase the user's gripping capability and comfort. This could include various padding or foam on the proximal handle grip 90 for increased comfort and any textured and or ribbed surfacing as well on the proximal handle grip 90 for increased gripping capability. The proximal handle grip 90 has two ends 92, one on each end 92 of the proximal handle grip 90 and a raised circumferential edge 94 disposed on each of its ends 92 for improved gripping.

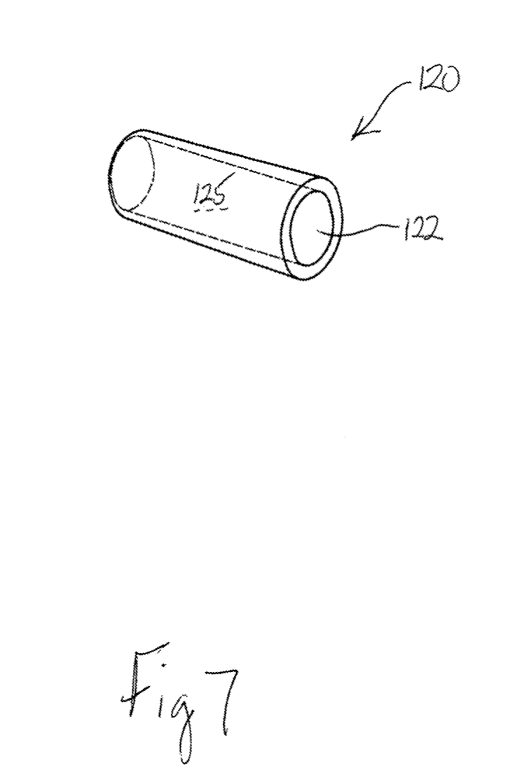

FIG. 7 illustrates a front side perspective view of a sledge hammer head guard of an improved long handle striking tool 120, in accordance with one embodiment of the present invention. The guard 120 simply has a fitted aperture 122 and a fitted interior 125 to accommodate a sledge hammer head 35 that is used with an improved long handle striking tool 10. The guard 120 provides basic protection for the sledge hammer head 35 and can be made of any materials that are well known to those schooled in the art for sledge hammer head guards.

All of the features of the improved long handle striking tool 10 are the same regardless of the type of striking tool head 30 used. In other words, an improved long handle striking tool 10 that has a sledge hammer head 35, an axe head (not shown), a pick axe head (not shown) or a maul head (not shown) would each have the same handle 20, distal end of the handle 22, proximal end of the handle 24, sliding handle assembly 40, movable bushing 50, assembly handle grip 60, optionally reinforced or non-reinforced head mount 70, head wedge 80, proximal handle grip 90 and plurality of removable threaded bolts 100 and tightening nuts 110 or other fastening devices. Any additional striking tool heads 30 not mentioned but are well known to those schooled in the art would also have the same remaining features of the improved long handle striking tool 10 as previous described.

The handle 20 and all of its components can also be utilized separately from the improved long handle striking tool 10. The components include a sliding handle assembly 40, a movable bushing 50, an assembly handle grip 60, a reinforced or non-reinforced head mount 70, a head wedge 80, a proximal handle grip 90 and a plurality of fastening devices such as a plurality of removable threaded bolts 100 and tightening nuts 110. The improved sliding handle 20 can be used in combination with any of the previously mentioned striking tool heads 30. The striking tool heads 30 would be the same as those used with the improved long handle striking tool 10 and can include, but are not limited to a sledge hammer head 35, a pick axe head (not shown), a maul head (not shown) and an axe head (not shown).

Use of the improved long handle striking tool 10 and improved striking tool handle 20 is straightforward. A user would grip the assembly handle grip 60 of the sliding handle assembly 40 with one hand and grip the proximal handle grip 90 with the other hand. A user can use his left hand or his right hand in gripping the assembly handle grip 60 and would use the other hand to grip the proximal handle grip 90. The long handled striking tool 10 can be used by left-handed or right-handed users. A user would use a typical swinging motion or technique that is well known to those schooled in the art to perform a striking work function with a striking tool, but would slide the sliding handle assembly 40 down from the approximate distal end of the handle 22 to the approximate proximal end of the handle 24, instead of loosening his grip on the distal end of a conventional long handle striking tool while sliding his loosened hand towards the proximal end of the conventional long handle striking tool. The sliding motion of the sliding handle assembly 40 along the handle 20 results in increased speed, accuracy, efficiency, power and impact, while also reducing the user's fatigue and improving the user's safety, in comparison to a user using a conventional long handle striking tool. The use of the improved long handle striking tool 10 or improved striking tool handle 20 is the same regardless of the striking tool head 30 used, and can include, but are not limited to a sledge hammer head 30, a pick axe head (not shown), a maul head (not shown) and an axe head (not shown).

While the present invention has been related in terms of the foregoing embodiments, those skilled in the art will recognize that the invention is not limited to the embodiments described. The present invention can be practiced. with modification and alteration within the spirit and scope of the appended claims. Thus, the description is to be regarded as illustrative instead of restrictive on the present invention.

What is claimed is:

1. An improved long handle striking tool used by a user, that provides increased speed, accuracy, efficiency, power and impact, that also reduces said user's fatigue and improves said user's safety, comprising:
a handle with a distal end and a proximal end;
a striking tool head disposed on said distal end of said handle that performs a striking work function;
a sliding handle assembly that slides along said handle when gripped by said user, said assembly includes a general sliding device to reduce friction and wear that is in direct slidable contact with said handle;
an assembly handle grip with two ends for said user to grip said assembly that is set on top of said general sliding device with a circumferential raised edge on each said end for improved gripping;
a plurality of fastening devices to hold said assembly handle grip and said general sliding device together forming said assembly, while allowing said assembly to slidably move along said handle;
a head mount that mounts said striking head to said distal end of said handle;
a head wedge that disposes said tool head on said distal end; and
a proximal handle grip with two ends on said proximal end of said handle that also allows said user to grip said handle with a raised circumferential edge on each said end for improved gripping.

2. The tool according to claim 1, wherein said tool head is an axe head.

3. The tool according to claim 2, wherein said tool head is a pick axe head.

4. The tool according to claim 1, wherein said tool head is a maul head, a sledge hammer head and any other long handled striking tool head.

5. The tool according to claim 4, wherein said sledge hammer head is provided with a sledge hammer head guard for protection.

6. The tool according to claim 1, wherein said general sliding device is a bushing used to reduce friction and wear and increase ease of use.

7. The tool according to claim 1, wherein said assembly handle grip utilizes materials and surfaces to increase said user's gripping capability and comfort.

8. The tool according to claim 1, wherein said head mount is reinforced to provide overstrike protection.

9. The tool according to claim 1, wherein said proximal handle grip is integral to said handle and said proximal grip and said handle are one piece.

10. The tool according to claim 1, wherein said proximal handle grip utilizes materials and surfaces to increase said user's gripping capability and comfort.

11. An improved long handle sliding striking tool handle used by a user, in combination with a striking tool head, that provides increased speed, accuracy, efficiency, power and impact, that also reduces said user's fatigue and improves said user's safety, comprising:
a handle with a distal end and a proximal end, said striking tool head disposed on said distal end of said handle that performs a striking work function;
a sliding handle assembly that slides along said handle when gripped by said user, said assembly includes a general sliding device to reduce friction and wear that is in direct slidable contact with said handle;
an assembly handle grip with two ends for said user to grip said assembly that is set on top of said general sliding device, with a raised edge on each said end for improved gripping;
a plurality of fastening devices to hold said assembly handle grip and said general sliding device together forming said assembly, while allowing said assembly to slidably move along said handle;
a head mount that mounts said striking head to said distal end of handle;
a head wedge that disposes said tool head on said distal end; and
a proximal handle grip with two ends attached on said proximal end of handle that also allows said user to grip said handle, with a raised edge on each said end for improved gripping.

12. The tool handle according to claim 11, wherein said tool head is an axe head.

13. The tool handle according to claim 12, wherein said tool head is a pick axe head.

14. The tool handle according to claim 11, wherein said tool head is a sledge hammer head

15. The tool handle according to claim 11, wherein said tool head is a maul head and any other long handled striking tool head.

16. The tool handle according to claim 11, wherein said general sliding device is a bushing used to reduce friction and wear and increase ease of use.

17. The tool handle according to claim 11, wherein said assembly hand grip utilizes materials and surfaces to increase said user's gripping capability and comfort.

18. The tool handle according to claim 11, wherein said head mount is reinforced to provide overstrike protection.

19. The tool handle according to claim 11, wherein said proximal handle grip is integral to said handle and said proximal grip and said handle are one piece.

20. The tool handle according to claim 11, wherein said proximal handle grip utilizes materials and surfaces to increase said user's gripping capability and comfort.
